(19) United States
(12) Patent Application Publication
(10) Pub. No.: US 2026/0057622 A1
(43) Pub. Date: Feb. 26, 2026

(54) THREE-DIMENSIONAL OBJECT INTERACTION CONTROL

(71) Applicant: Adobe Inc., San Jose, CA (US)

(72) Inventors: David McKinley Cardwell, Toronto (CA); Salvador German Soto Gutierrez, Toronto (CA); Inigo Quilez les, San Francisco, CA (US)

(73) Assignee: Adobe Inc., San Jose, CA (US)

(21) Appl. No.: 18/815,774

(22) Filed: Aug. 26, 2024

(51) Int. Cl. G06T 19/20; G06T 13/40

(52) U.S. Cl. CPC G06T 19/20; G06T 13/40; G06T 2210/21; G06T 2219/2004; G06T 2219/2012; G06T 2219/2021

(57) ABSTRACT

Three-dimensional object interaction control techniques are described. In one or more examples, a selection of a mode from a plurality of modes is received specifying object interactions in a user interface. An input is received via the user interface specifying movement of a first object in relation to a second object. An intersection is detected between a first three-dimensional volume defined for the first object with a second three-dimensional volume defined for the second object. An image editing operation is performed based on the mode and the detected intersection. A result of performing the image editing operation on the first and second objects is presented in the user interface.

### BACKGROUND

Three-dimensional environments have been developed to expand a visual richness into what can be perceived within the environment as well as a richness in user interaction within the environment. Creation of digital content that supports a three-dimensional environment, however, is confronted with numerous technical challenges. These technical challenges are typically introduced by complexity by a nature of the three-dimensional environment as well as operations used to edit the three-dimensional environment.

Content creators familiar with operations used by conventional content editing systems used to create two-dimensional content, for instance, are generally unfamiliar with changes to operations introduced by these technical challenges. As a result, content creators when confronted with conventional content creation systems often forgo use of this functionality or engage in prolonged and inefficient manual interaction with the content creation systems. These complications in real world scenarios result in a corresponding decrease in operation and computational functionality of computing devices that implement these techniques, cause user frustration, and so forth.

### SUMMARY

Three-dimensional object interaction control techniques and systems are described. In a one or more examples, a selection of a mode from a plurality of modes is received specifying object interactions in a user interface. An input is received via the user interface specifying movement of a first object in relation to a second object. An intersection is detected between a first three-dimensional volume defined for the first object with a second three-dimensional volume defined for the second object. An image editing operation is performed based on the mode and the detected intersection. A result of performing the image editing operation on the first and second objects is presented in the user interface.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ three-dimensional object interaction control techniques described herein.

FIG. 2 depicts a system in an example implementation showing operation of an object interaction module of FIG. 1 in greater detail.

FIG. 3 depicts a system in an example implementation showing execution of an add operation as part of an add mode to control object interaction in a user interface.

FIG. 4 depicts a system in an example implementation showing execution of a carve operation as part of a carve mode to control object interaction in a user interface.

FIG. 5 depicts a system in an example implementation showing execution of an intersect operation as part of an intersect mode to control object interaction in a user interface.

FIG. 6 depicts a system in an example implementation showing execution of a color operation as part of a color mode to control object interaction in a user interface.

FIG. 7 depicts a system in an example implementation showing execution of a repel operation as part of a repel mode to control object interaction in a user interface.

FIG. 8 depicts a system in an example implementation showing execution of an avoid operation as part of an avoid mode to control object interaction in a user interface.

FIG. 9 is a flow diagram depicting a step-by-step procedure in an example implementation of operations performable by a processing device for accomplishing a result of three-dimensional object interaction control.

FIG. 10 depicts a system in an example implementation showing operation of a content navigation module of FIG. 1 in greater detail as generating an operation stack of operation representations based on monitored operations used to generate a three-dimensional environment.

FIG. 11 is a flow diagram depicting an algorithm as a step-by-step procedure in an example implementation of operations performable for accomplishing a result of operation stack generation having operation representations of operations used to generate an item of digital content.

FIG. 12 depicts a system in an example implementation showing operation of a digital search service of the digital services of FIG. 1 in greater detail as locating an item of digital content having an operation stack.

FIG. 13 is a flow diagram depicting an algorithm as a step-by-step procedure in an example implementation of operations performable for accomplishing a result of a digital content search to locate an item of digital content.

FIG. 14 depicts a system in an example implementation showing operation of a content navigation module of FIG. 1 in greater detail as implementing a content navigation control to navigate through an operation stack of an item of digital content.

FIG. 15 depicts a system in an example implementation showing interaction with a content navigation control to navigate through an operation stack to initiate creation of a new item of digital content.

FIG. 16 is a flow diagram depicting an algorithm as a step-by-step procedure in an example implementation of operations performable for accomplishing a result of navigation through operation representations to control output of corresponding versions of digital content using a content navigation control.

FIG. 17 illustrates an example system including various components of an example device that can be implemented as any type of computing device as described and/or utilize with reference to the previous figures to implement embodiments of the techniques described herein.

### DETAILED DESCRIPTION

### Overview

Three-dimensional environments have been developed to expand functionality available from digital content, e.g., over functionality made available via a two-dimensional environment. A three-dimensional environment, for instance, is configurable to define three-dimensional objects within the environment to support changes in a viewpoint in relation to the three-dimensional environment, positions of a light source within the three-dimensional environment, positioning of the three-dimensional objects in relation to each other, and so on.

However, technical challenges and user inefficiencies are introduced by conventional content editing systems when attempting to create and edit digital content that supports a three-dimensional environment, e.g., a three-dimensional object such as an isometric shape. Examples of these challenges include challenges in understanding operations that are targeted for use in a three-dimensional environment and how to define a relationship of different three-dimensional objects with each other within the environment.

Accordingly, three-dimensional object interaction control techniques and systems are described that address these technical challenges to improve user efficiency in interaction with a user interface that supports three-dimensional environment edits, manipulation, and illumination. As a result, these techniques and systems improve operation of computing devices that implement the techniques, increase user interaction efficiency with corresponding user interfaces, and aid user understanding in addressing the technical challenges involved in three-dimensional object editing.

In one or more examples, an object interaction module is configured to support a variety of modes usable to control how objects in the three-dimensional object interact, e.g., when moved and positioned in relation to each other as part of creating digital content. A user interface, for instance, is output as having representations of the modes which are then used to control the object interactions. Selection of the modes causes execution of respective operations that then implement the control of the object interactions. Each of these operations are based on respective three-dimensional volumes of respective shapes and the relationship of these volumes to each other. Operation examples include an add operation, a carve operation, an intersect operation, a color operation, a repel operation, an avoid operation, and so forth.

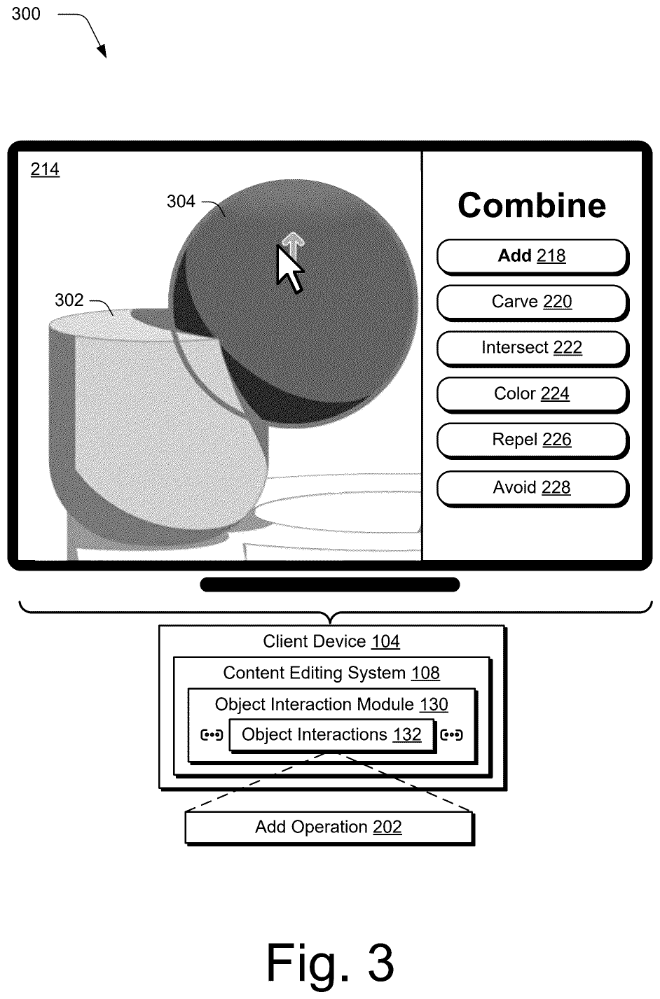

For an add operation, a first three-dimensional volume defined for a first object appears disposed within a second three-dimensional volume defined for a second object in the user interface. The three-dimensional volumes of the first object and second objects in this example intersect each other as part of a defined overlap in relation to each other, i.e., visually appear to “occupy a same space” in the user interface. Portions of the first and second objects that do not overlap appear “as is” in this example, i.e., without modification. An example of the add operation is further described in relation to FIG. 3.

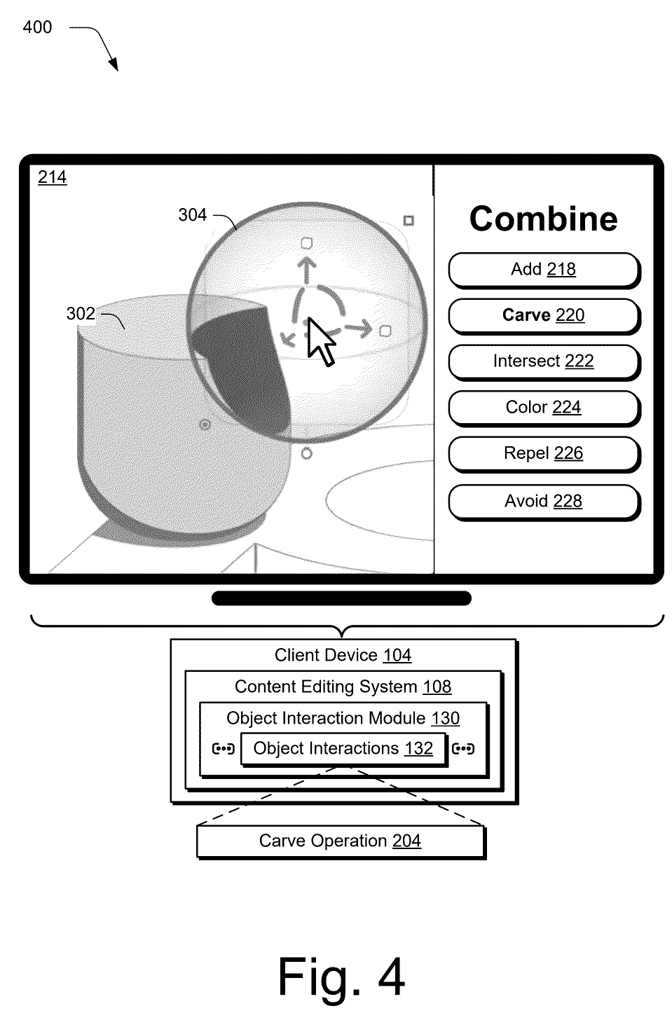

In a carve operation, a portion of a first three-dimensional volume of a first object is removed in the user interface that intersects a second three-dimensional volume defined for a second object. The second object, for instance, when moved to overlap the first object causes a portion of the first object that intersects the second object to be eliminated from view in the user interface. The first object may therefore be displayed solely in the user interface with that “carved out” portion as appearing to be removed. An underlying mathematical representation of the first object, in one or more examples, is unchanged but rather an appearance of the object in the user interface is changed, thereby supporting additional edits. An example of the carve operation is further described in relation to FIG. 4.

In an intersect operation, a portion of both the first object and the second object is removed in the user interface that are nonintersecting on respective three-dimensional volumes, yet other portions of the first and second object that are intersecting remain. The second object, in this example, when moved to overlap the first object causes a portion of the first object and/or the second object that intersect each other to remain. Other portions of the first and second objects that are nonintersecting are removed.

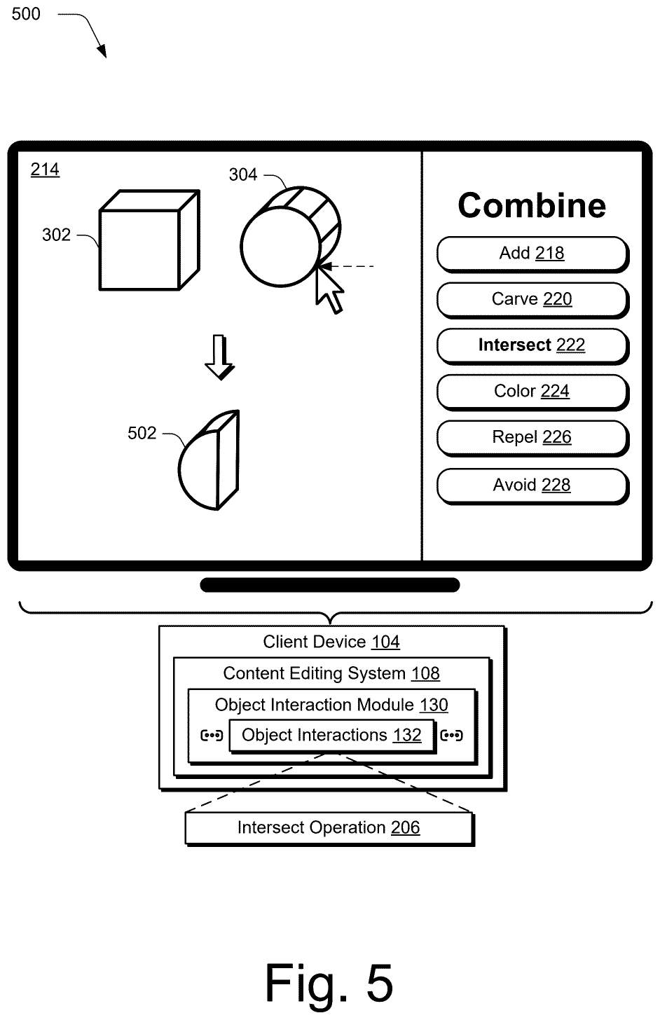

The first and second objects therefore are both displayed in the user interface, in which, the intersecting portions remain. Like the previous example, underlying mathematical representations of the first and second objects are unchanged but rather an appearance of the first and second objects in the user interface are changed, thereby support additional edits including removal of the edit from subsequent versions of the digital content. An example of the intersect operation is further described in relation to FIG. 5.

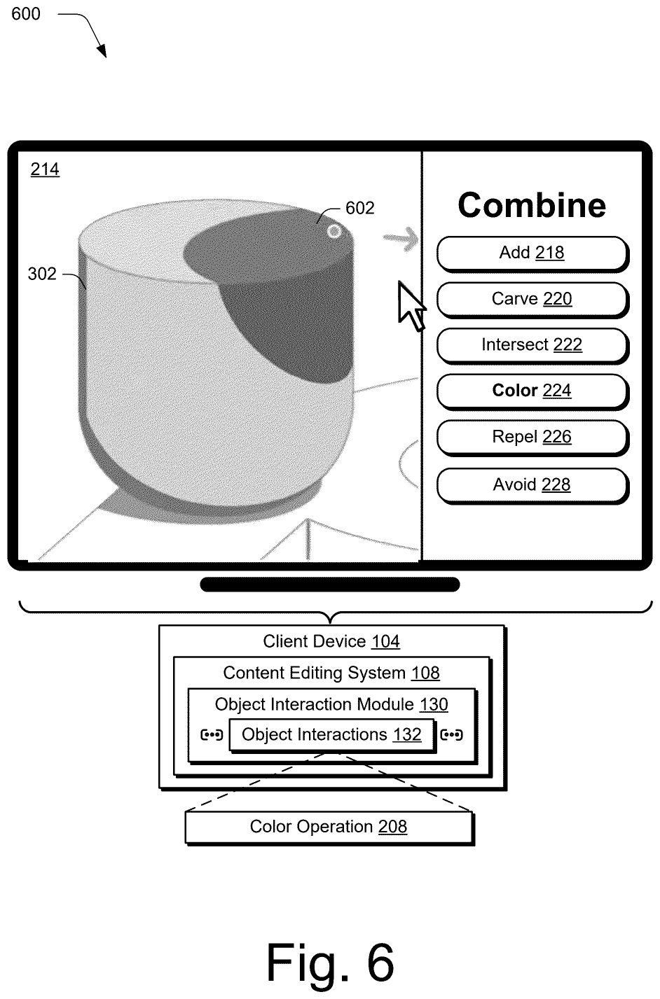

In a color operation, the first and second objects intersect and are positioned to overlap such that first and second three-dimensional volumes defined respectively for the first and second objects occupy a same space. In this example, however, a portion of a surface of the first three-dimensional volume that intersects the second three-dimensional volume defined for the second object is defined to have a color based on the second object. The second object, for instance, is assigned a color in this example but is not configured for display in a final output of the digital content. Rather, intersection of the second object with the first object (and more particularly three-dimensional volumes of the objects) is used to control a color applied to a surface of the first object that corresponds to the intersection. This feature is usable to provide additional edits to the first object, such as to define stripes on a basketball. An example of the color operation is further described in relation to FIG. 6.

For a repel operation, a portion of a first three-dimensional volume of the first object that intersects a second three-dimensional volume defined for second object is repelled from the second object. The first object, for instance, is “repelled” as following movement defined by an input that defines movement of the first and second objects in relation to each other. For example, inputs are received that involve selection of the second object and then movement of the second object towards the first object. Portions of the first object that are within a threshold distance of the second object are repelled away from the second object, e.g., within a three-dimensional volume defined for the second object.

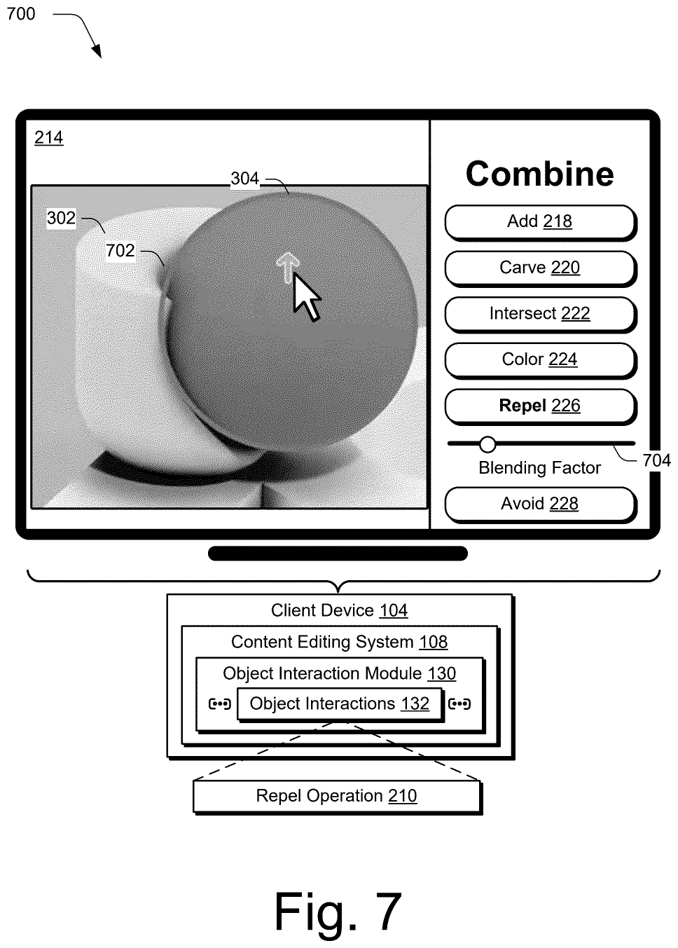

A distance, in one or more implementations, is defined as a “gap” that is to appear between the first and second objects. The distance is user definable via the user interface, e.g., using a slider control, dial, numerical value, and so forth. Therefore, in this example as the first and second objects are moved in relation to each other, a surface of the first three-dimensional volume defined for the first object is “repelled” by a surface of the second three-dimensional volume defined for the second object while showing a space in between. An example of the repel operation is further described in relation to FIG. 7.

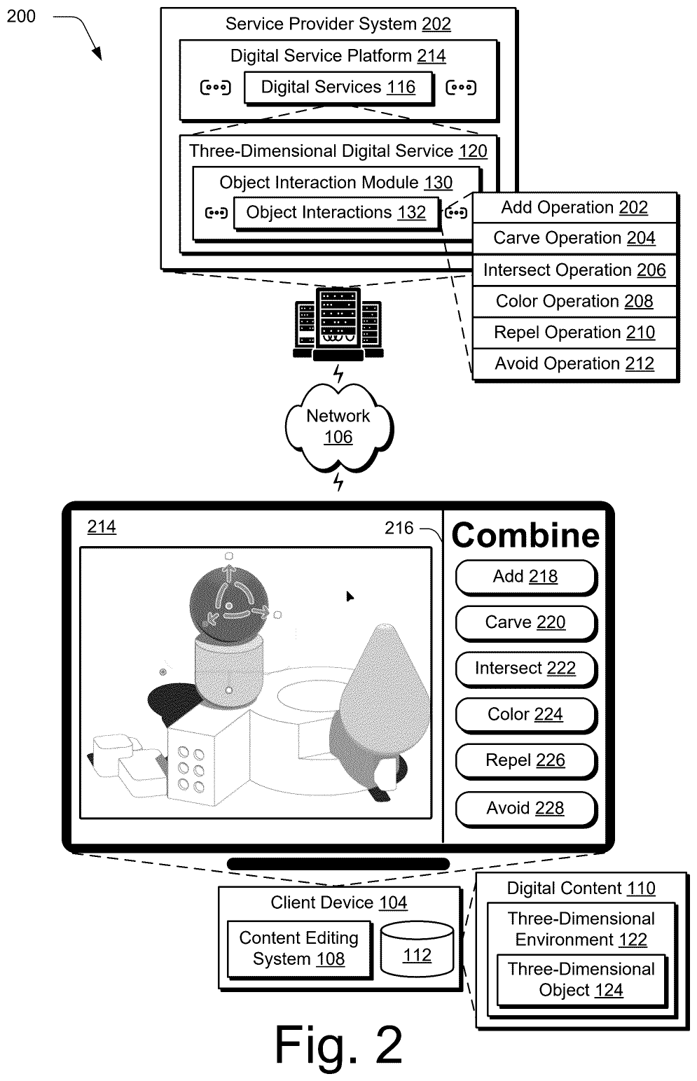

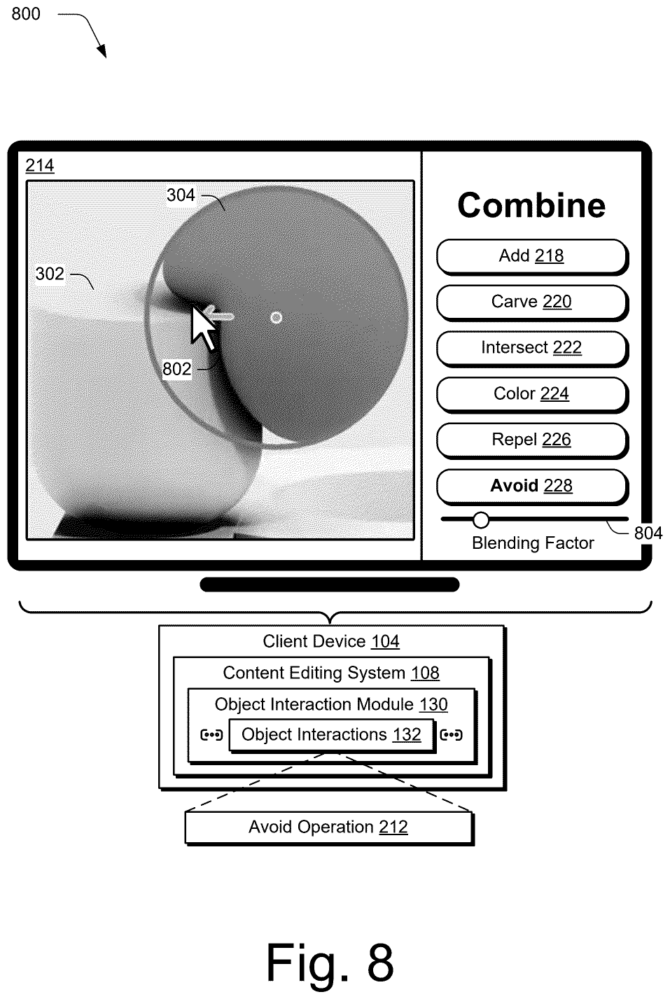

For an avoid operation, a portion of a second three-dimensional volume of a second object that intersects a first three-dimensional volume defined for first object avoids the first object, e.g., as following movement defined by an input that defines movement of the first and second objects in relation to each other. Like the repel operation, the portion of the second object may avoid the first object within confines of a three-dimensional object defined for the second object. A distance is also definable as a “gap” that is to appear between the first and second objects. Therefore, in this example as the first and second objects are moved in relation to each other, a surface of the second three-dimensional volume defined for the second object “avoids” a surface of the first three-dimensional volume defined for the first object while showing a space disposed between the objects. An example of the repel operation is further described in relation to FIG. 8. Further discussion of these and other object interaction examples are described in relation to FIGS. 2-9.

In one or more additional examples, a content navigation control is implemented by a content editing system to aid navigation through a history of how a three-dimensional (3D) environment and a three-dimensional object included in the environment is created. Further, the content navigation control supports attribution of operations using attribution data to respective entities that initiated performance of the respective operations as part of creating the digital content, thereby promoting sharing between creatives.

The content editing system, for instance, is configured to support operations to edit (e.g., create) digital content having a three-dimensional (3D) object. During editing of the digital content, inputs are received by the content editing system to execute corresponding operations as part of creating the three-dimensional object. Attribution data is also collected (e.g., as user tags, user credentials, aliases, and so forth) that attribute these operations to respective entities that initiated the operations, e.g., user identifiers as part of a content creation digital service that are then usable to locate the entities.

Operation representations are generated by the content editing system by monitoring receipt of the inputs. For example, an operation representation references a respective executed operation, i.e., the operation is referenced by the operation representation. The content editing system, in one or more examples, generates an operation stack having operation representations and attribution data in an ordered sequence following an order, in which, the inputs are received. The operation sequence therefore defines a creative process used to generate an item of digital content having a three-dimensional environment, e.g., includes a three-dimensional object. The operation sequence also references entities that participated in respective portions of the creative process, which is not possible in conventional techniques. The operation sequence is storable as part of the digital content (e.g., as metadata associated with the digital content), as a separate file, and so forth.

The operation sequence then supports an ability to view how the digital content is created and “who” created the digital content. A collection of representations of digital content, for instance, may be included for display in a user interface, e.g., accessible via a social network digital service, a stock digital service, and so on. The representations are selectable to display the digital content along with a corresponding content navigation control.

The content navigation control supports navigation through the operation stack to respective operation representations and corresponding operations used to generate the digital content. Representations are also included of the entities that participated in creating that version of the digital content, e.g., as icons that are selectable to output additional information about the entities nonmodally in the user interface. A version of the digital content displayed in the user interface, therefore, is editable and as such provides increased functionality over conventional teaching techniques that rely on a video to records digital content creation but does not support user interaction.

In an implementation, the operation sequence also includes operation representations of operations that are “backed out” (i.e., deleted, removed, “undone”, and so forth) and thus are not used to generate a final version of the digital content. Attribution data is also storable along with these operations. In other words, generation of the final version is performed independent of these operations. In this way, user interaction is supported with increased insight into viewing potential mistakes that are made, who made those mistakes, and how those mistakes are subsequently rectified (and by whom) in generating the digital content, which is also not possible in conventional techniques.

The operation stack further supports definition of a starting point to generate a “new” item of digital content, e.g., as a “remix” of the digital content. A creative professional, for instance, may view an item of digital content of interest at a digital service that provides stock digital content but desire to make changes to the item of digital content. Access to the item of digital content may therefore be purchased by a creative professional, e.g., through the stock digital service as a one-time fee or subscription.

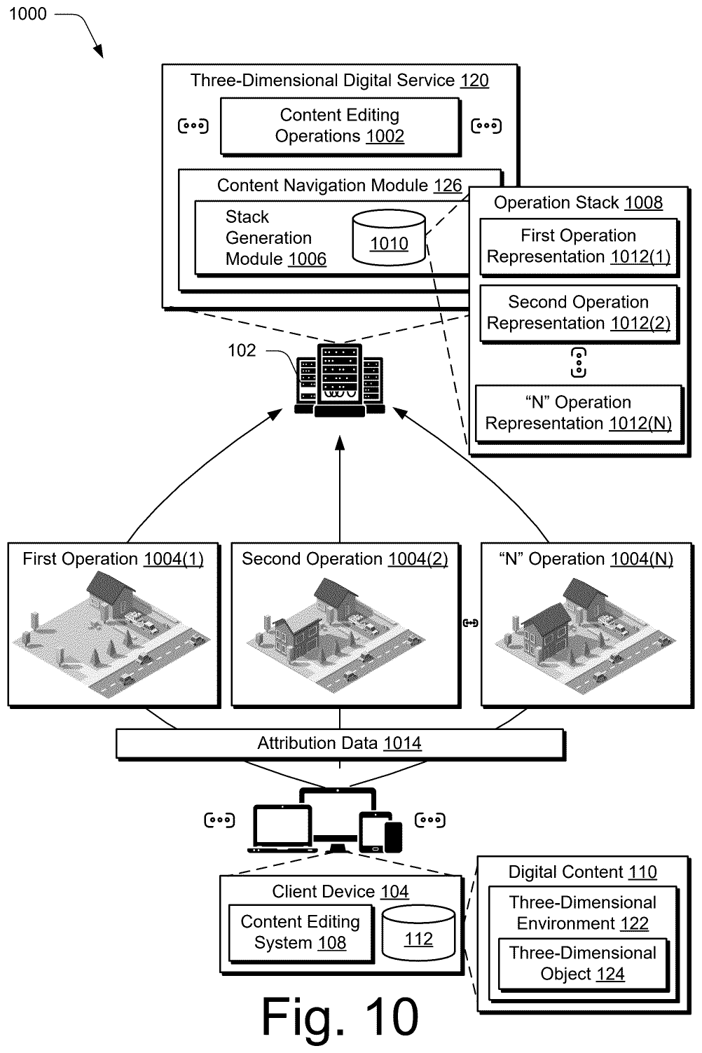

The creative professional then interacts with the content navigation control to navigate to a point of interest and provide subsequent inputs to create the new item of digital content using that point of interest as a starting point. The operation stack may also be updated to reflect these changes, e.g., by including operation representations of subsequent operations and attribution data of the creative professional as well. In this way, user interaction and computational efficiency is increased, e.g., for a creative professional to create a multitude of related digital content. Further discussion of these and other content navigation control examples are described in relation to FIGS. 10-16.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Three-dimensional Object Interaction Environment

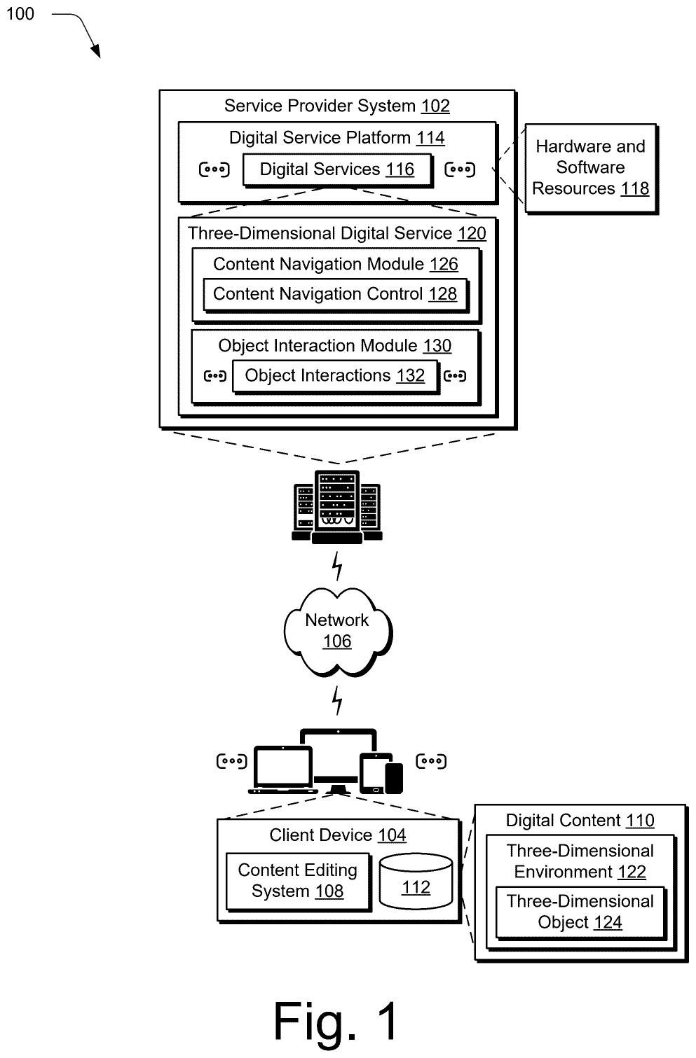

FIG. 1 is an illustration of a digital medium environment 100 in an example implementation that is operable to employ three-dimensional object interaction control techniques described herein. The illustrated environment 100 includes a service provider system 102 and a client device 104 that are communicatively coupled, one to another, via a network 106. Computing devices that implement the service provider system 102 and the client device 104 are configurable in a variety of ways.

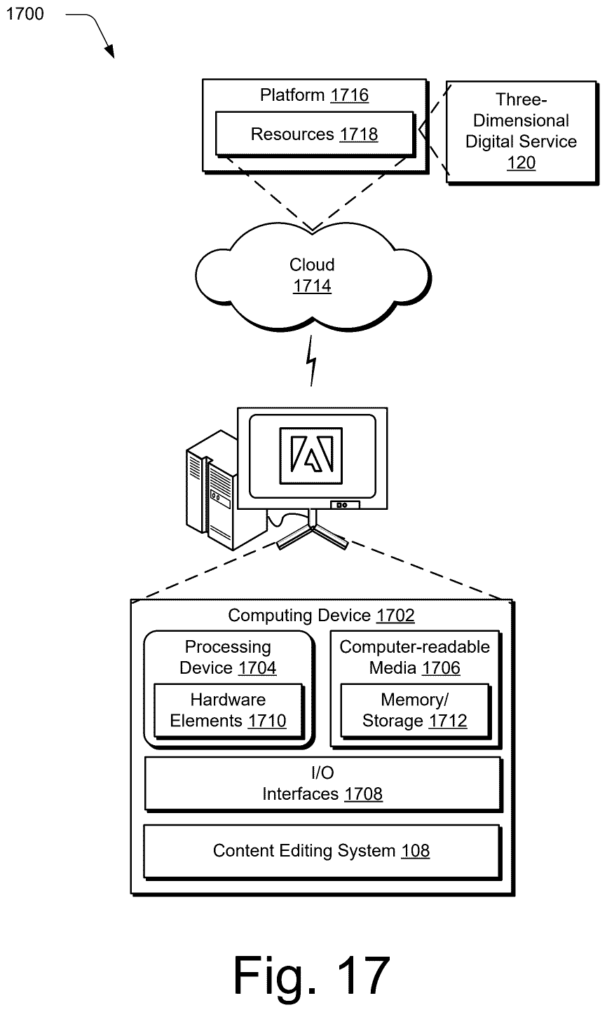

A computing device, for instance, is configurable as a desktop computer, a laptop computer, a mobile device (e.g., assuming a handheld configuration such as a tablet or mobile phone as illustrated), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown and described in some examples, a computing device is also representative of a plurality of different devices, such as multiple servers utilized by a business to perform operations “over the cloud” as described in FIG. 17.

The client device 104 is illustrated as including a content editing system 108. The content editing system 108 is implemented at least partially in hardware of the client device 104 to process and transform digital content 110, which is illustrated as maintained in a storage device 112 of the client device 104. Such processing includes creation of the digital content 110, modification of the digital content 110, and rendering of the digital content 110 in a user interface for output, e.g., by a display device.

The service provider system 102 is illustrated in this example as implementing a digital service platform 114 to provide digital services 116 through execution of hardware and software resources 118. The digital services 116 are representative of functionality made available by the service provider system 102 via the network 106 to the client device 104. In a first instance, the digital services 116 include a social network service that is executable to share communications, posts, digital content, and so forth. In a second instance, the one or more digital services 116 include a stock digital service that is configured to provide access to digital content (e.g., for a fee) that is located using a digital search service.

In the illustrated instance, the digital services 116 include a three-dimensional digital service 120. The three-dimensional digital service 120 is configured to operate in this example in conjunction with the content editing system 108 to support functionality to edit (e.g., create) a three-dimensional environment 122 and a three-dimensional object 124 disposed within the three-dimensional environment 122. Although illustrated as implemented at the service provider system 102 as one of the digital services 116, this functionality may also be implemented locally at the client device 104, e.g., solely by the content editing system 108.

The three-dimensional digital service 120 supports a variety of functionality that is configured to support and implement editing of the three-dimensional environment 122 and the three-dimensional object 124. Examples of which to do so are represented as a content navigation module 126 configured to implement a content navigation control 128 and an object interaction module 130 configured to control object interactions 132 between three-dimensional objects 124 in the digital content 110.

The content navigation module 126 is configured to generate an operation stack that identifies operations (e.g., image editing operations) used to generate the digital content 110. The content navigation control 128 is then utilized to navigate through the operation stack and view corresponding versions of the three-dimensional environment 122 and three-dimensional object 124. These versions are also usable to support further editing, and thus increase efficiency in creation of additional digital content, such as to generate differences in the three-dimensional environment 122 and the three-dimensional object 124, further discussion of which may be found in relation to FIGS. 10-16 in a corresponding section.

The object interaction module object interaction module 130 is configured to support a variety of modes usable to control how objects in the three-dimensional object interact as part of object interactions 132, e.g., contact, proximity, overlap, and so forth. Image editing operations are then performable to output a result of those interactions and may do so without changing an underlying mathematical definition of the objects.

A user interface, for instance, is output having representations of modes which are then used to control the object interactions 132. Selection of the modes through respective representations causes execution of respective image editing operations that then implement the control. Each of these image editing operations are configurable to control interactions based on respective three-dimensional volumes of respective shapes and a relationship of the volumes to each other. Image editing operation examples include an add operation, a carve operation, an intersect operation, a color operation, a repel operation, an avoid operation, and so forth as further described in relation to FIGS. 2-9 and in a corresponding section.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Three-dimensional Object Interaction Control

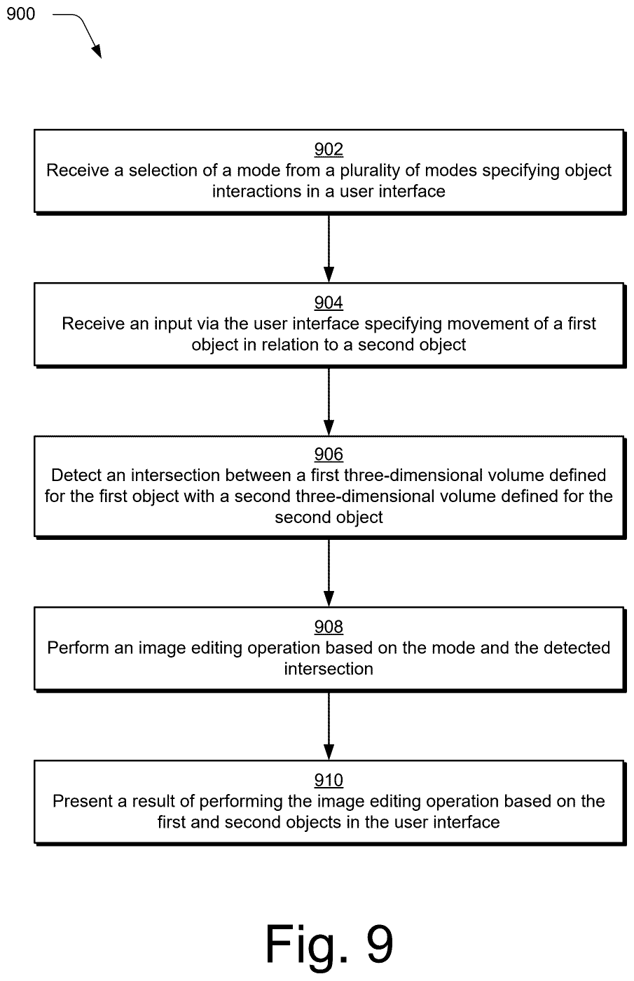

The following discussion describes three-dimensional object interaction control techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm. FIG. 9 is a flow diagram depicting a step-by-step procedure 900 in an example implementation of operations performable by a processing device for accomplishing a result of three-dimensional object interaction control. In portions of the discussion, reference is made in parallel to FIG. 9.

FIG. 2 depicts a system 200 in an example implementation showing operation of the object interaction module 130 of FIG. 1 in greater detail. The object interaction module 130, as previously described, is configured to support a variety of modes usable to control how objects in the three-dimensional object interact, e.g., when moved and positioned in relation to each other as part of creating digital content. To do so, each mode supports corresponding image editing operations that control how these interactions occur. Examples of the image editing operations include an add operation 202, a carve operation 204, an intersect operation 206, a color operation 208, a repel operation 210, and an avoid operation 212.

A user interface 214, for instance, is illustrated as displayed on a display device of the client device 104. The user interface 214 includes a depiction of three-dimensional objects and a sidebar 216. The user interface 214 also includes representations that are selectable to enter respective modes. Illustrated examples of which include an add 218 representation, a carve 220 representation, an intersect 222 representation, a color 224 representation, a repel 226 representation, and an avoid 228 representation.

A selection, for instance, is received by the object interaction module 130 to select a mode from a plurality of modes specifying object interactions in a user interface (block 902), e.g., using one of the representations. An input is also received by the object interaction module 130 specifying movement of a first object in relation to a second object (block 904). The input, for instance, may involve selection of an object and subsequent movement of the object through a “click-and-drag” performed using a cursor control device, a gesture, via a keyboard, and so forth.

Responsive to the input, the object interaction module 130 detects an intersection between a first three-dimensional volume defined for the first object with a second three-dimensional volume defined for a second object (block 906). An image editing operation is then performed by the object interaction module 130 based on the mode and the detected intersection (block 908) to implement the object interactions 132 defined for the respective mode. A result of performing the image editing operation based on the first and second objects is presented (block 910), e.g., for display in the user interface 214. A variety of object interactions 132 are supported through the respective modes, examples of which are described as follows and shown in corresponding figures.

FIG. 3 depicts a system 300 in an example implementation showing execution of an add operation 202 as part of an add mode to control object interaction in a user interface. The add 218 representation is illustrated as selected in this example via the user interface 214 to control object interaction.

For an add operation 202, a first three-dimensional volume defined for a first object 302 appears disposed within a second three-dimensional volume defined for a second object 304 in the user interface 214. The three-dimensional volumes of the first object 302 and second object 304 in this example intersect each other as part of a defined overlap. In other words, the first and second objects 302, 304 visually appear to “occupy a same space” in the user interface 214. Portions of the first and second objects 302, 304 that do not overlap appear “as is” in this example, i.e., without modification. In this way, the first and second objects 302, 304 are “added together” in this example through use of the add operation 202. An underlying mathematical definition of the first and second objects 302, 304 is not changed in the example such that further edits are also supported, such as to “remix” the digital context as previously described to form new versions of the digital content.

FIG. 4 depicts a system 400 in an example implementation showing execution of a carve operation 204 as part of an carve mode to control object interaction in a user interface 214. The carve 220 representation is illustrated as selected in this example via the user interface 214 to control object interactions.

In a carve operation, a portion of a first three-dimensional volume of a first object 302 is removed in the user interface that intersects a second three-dimensional volume defined for a second object 304. The second object 304, in this example, when moved to overlap the first object 302 causes a portion of the first object 302 that intersects the second object 304 to be removed. The first object 302 may therefore be displayed solely in the user interface 214 with that “carved out” portion as appearing to be removed. An underlying mathematical representation of the first object is unchanged but rather an appearance of the object in the user interface is changed, thereby supporting additional edits.

FIG. 5 depicts a system 500 in an example implementation showing execution of an intersect operation 206 as part of an intersect mode to control object interaction in a user interface. The intersect 222 representation is illustrated as selected in this example via the user interface 214 to control object interaction using an intersect operation 206 using first and second objects 302, 304.

In an intersect operation 206, a portion of both a first object 302 and a second object 304 is removed in the user interface that are nonintersecting based on respective three-dimensional volumes. However, other portions of the first and second objects that are intersecting remain.

The second object 304, in this example, when moved to overlap the first object 302 causes a portion of the first object that intersects the second object to remain. A corresponding portion of the second object also remains. Other portions are removed such that a result 502 of a cube of the first object 302 and a cylinder of the second object 304 forms a half cylinder in the illustrated example. Like the previous example, underlying mathematical representations of the first and second objects are unchanged but rather an appearance of the first and second objects in the user interface are changed, thereby support additional edits including removal of the edit from subsequent versions of the digital content.

FIG. 6 depicts a system 600 in an example implementation showing execution of a color operation 208 as part of a color mode to control object interaction in a user interface. The color 224 representation is illustrated as selected in this example via the user interface 214 to control object interaction.

In a color operation 208, the first and second objects intersect and are positioned to overlap such that first and second three-dimensional volumes defined respectively for the first and second objects occupy a same space. In this example, however, a portion 602 of a surface of the first three-dimensional volume of the first object 302 that intersects the second three-dimensional volume defined for the second object is defined to have a color based on the second object.

The second object, for instance, is assigned a color but is not configured for display in a final output of the digital content in the user interface 214. Rather, intersection of the second object with the first object (and more particularly three-dimensional volumes of the objects) is used to control a color applied to a portion 602 of a surface of the first object 302 that corresponds to the intersection. As before, an underlying mathematical definition of the first and second objects 302, 304 is not changed in the example such that further edits are also supported.

FIG. 7 depicts a system 700 in an example implementation showing execution of a repel operation 210 as part of a repel mode to control object interaction in a user interface. The repel 226 representation is illustrated as selected in this example via the user interface 214.

For a repel operation 210, a portion of a first three-dimensional volume of the first object 302 that intersects a second three-dimensional volume defined for second object is repelled from the second object 304. The first object 302, for instance, is “repelled” as following movement defined by an input that defines movement of the first and second objects 302, 304 in relation to each other. In one or more examples, the portion that is repelled is defined within the three-dimensional volume that defines the first object 302, e.g., is removed from within the volume based on proximity to the second object 304.

In the illustrated example, a distance 702 is defined as a “gap” that is to appear between the first and second objects 302, 304. The distance is user definable via the user interface 214, e.g., using a “blending factor” 704 as implemented using a slider control, dial, numerical value, and so forth. Therefore, in this example as the first and second objects 302, 304 are moved in relation to each other, a surface of the first three-dimensional volume defined for the first object 302 is “repelled” by a surface of the second three-dimensional volume defined for the second object 304 while showing a space in between. The surface is deformed within the three-dimensional volume of the second object 304 based on proximity. Similar blending factors may be utilized for add, carve, intersect, color and so on as described in relation to FIGS. 3-6. An underlying mathematical definition of the first and second objects 302, 304 is not changed in the example such that further edits are also supported.

FIG. 8 depicts a system 800 in an example implementation showing execution of an avoid operation 212 as part of an avoid mode to control object interaction in a user interface. The avoid 228 representation is illustrated as selected in this example via the user interface 214 to control object interaction.

For an avoid operation 212, a portion of a second three-dimensional volume of a second object 304 that intersects a first three-dimensional volume defined for first object 302 avoids the first object 302, e.g., as following movement defined by an input that defines movement of the first and second objects in relation to each other. Like the repel operation, the portion is defined within a three-dimesnional volume of the second object 304 that gives an appearance of deforming a surface of the second object 304 based on proximity to the first object 302.

For the avoid operation 212, a distance 802 is also definable as a “gap” that is to appear between the first and second objects, e.g., as a blending factor 804. Therefore, in this example as the first and second objects 302, 304 are moved in relation to each other, a surface of the second three-dimensional volume defined for the second object 304 “avoids” a surface of the first three-dimensional volume defined for the first object 302 while showing a space disposed between the objects as defined by the distance 802. Again, an underlying mathematical definition of the first and second objects 302, 304 is not changed in the example such that further edits are also supported. In this way, the object interaction module 130 is configured to support a variety of modes usable to control how objects in the three-dimensional object interact, e.g., when moved and positioned in relation to each other as part of creating digital content.

### Example Content Navigation Control and Operation Stack

The following discussion describes content navigation control and operation techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

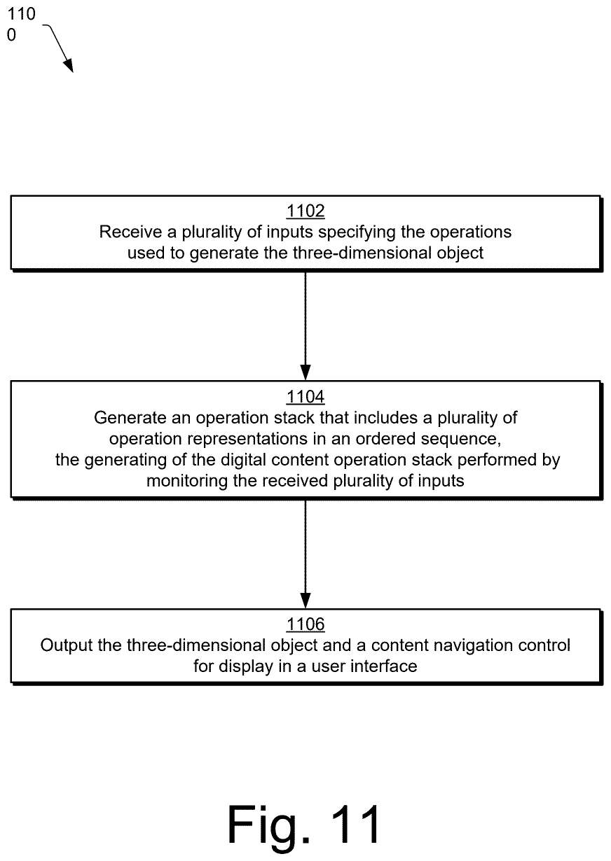

FIG. 10 depicts a system 1000 in an example implementation showing operation of the content navigation module 126 of FIG. 1 in greater detail as generating an operation stack of operation representations based on monitored operations used to generate a three-dimensional environment 122. FIG. 11 is a flow diagram depicting an algorithm as a step-by-step procedure 1100 in an example implementation of operations performable for accomplishing a result of operation stack generation having operation representations of operations used to generate an item of digital content. The following discussion of the system 1000 of FIG. 2 is made in parallel with the procedure 1100 of FIG. 11.

The three-dimensional digital service 120 in the illustrated scenario supports a plurality of content editing operations 1002 that are executable to edit (e.g., create) the three-dimensional environment 122 (e.g., the three-dimensional object 124) as part of the digital content 110. The plurality of content editing operations 1002, for instance, are configurable to form the three-dimensional object 124 as isometric shapes, define the three-dimensional object using signed distance functions (SDFs), define a location of a light source within the three-dimensional environment 122, position the three-dimensional object 124 within the three-dimensional environment 122 (e.g., in relation to another three-dimensional object), and so on.

The content editing system 108, for instance, is configured to communicate with the three-dimensional digital service 120 via the network to specify a first operation 1004(1) input, second operation 1004(2) input, . . . , through an “N” operation 1004(N) input. In this illustrated example, the inputs specifying the plurality of content editing operations 1002 are used to generate the three-dimensional object 124 as a house within the three-dimensional environment 122 of a neighborhood yard.

The content navigation module 126, therefore, receives the plurality of inputs as specifying the operations used to generate the three-dimensional object 124 (block 1102). A stack generation module 1006 is then utilized by the content navigation module 126 to generate an operation stack 1008 by monitoring the received plurality of inputs, which is stored in a storage device 1010.

The operation stack 1008 includes a plurality of operation representations in an ordered sequence (block 1104), e.g., based on a sequence in which the inputs are received from the client device 104. The operation stack 1008, for instance, is configurable as a tech stack (e.g., in accordance with Elixir) having operation representations. The operation representations are included in the operation stack 1008 as an ordered sequence that corresponds to a sequence, in which, the inputs are received, e.g., as a first operation representation 1012(1), second operation representation 1012(2), . . . , through “N” operation representations 1012(N). The operation representations, in one or more implementations, are executable as instructions to cause corresponding content editing operations 1002 to be performed to generate a corresponding version of the digital content 110, e.g., using corresponding collections of the operations.

In an implementation, the operation stack 1008 includes operation representations for each of the operations received as inputs by the stack generation module 1006, even in instances in which the operations did not contribute to a final version of the digital content 110, e.g., were “backed out. ” A creative, for instance, interacts with the content editing system 108 to specify an input, a result of which is no longer desired and therefore is modified, made subject to an “undo” operation, and so forth. Thus, in this implementation the operation stack 1008 is “complete” in that each operation received as an input is included in the operation stack 1008 as part of editing the three-dimensional environment 122.

The operation stack 1008 is also configured in this example to include attribution data 1014 that identifies entities that initiated corresponding image editing operations. The attribution data 1014, for instance, is configurable as user tags, user aliases, or other identifying data usable to identify “who” initiated the corresponding operations, e.g., the first, second, and “N” operations 1004(1), 1004(2), 1004(N).

As a result, the operation stack 1008 provides a source of information regarding creation and attribution of the three-dimensional environment 122 and three-dimensional object 124, e.g., for an entirety of how the digital content 110 is created in practice in the above implementation. Other implementations are also contemplated in which the operation stack 1008 includes operation representations, solely or partially, of operations that contributed towards generation of the digital content 110. The three-dimensional object 124 and a content navigation control are then output for display in a user interface (block 1106) to support navigation through the operation stack 1008 as further described in the following discussion.

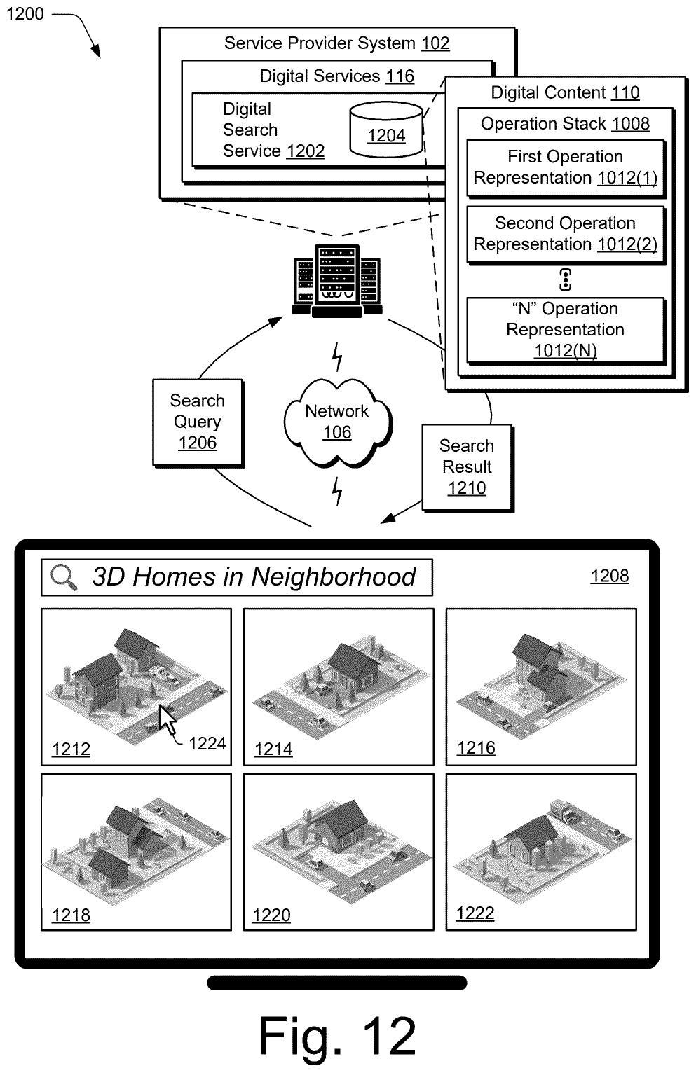

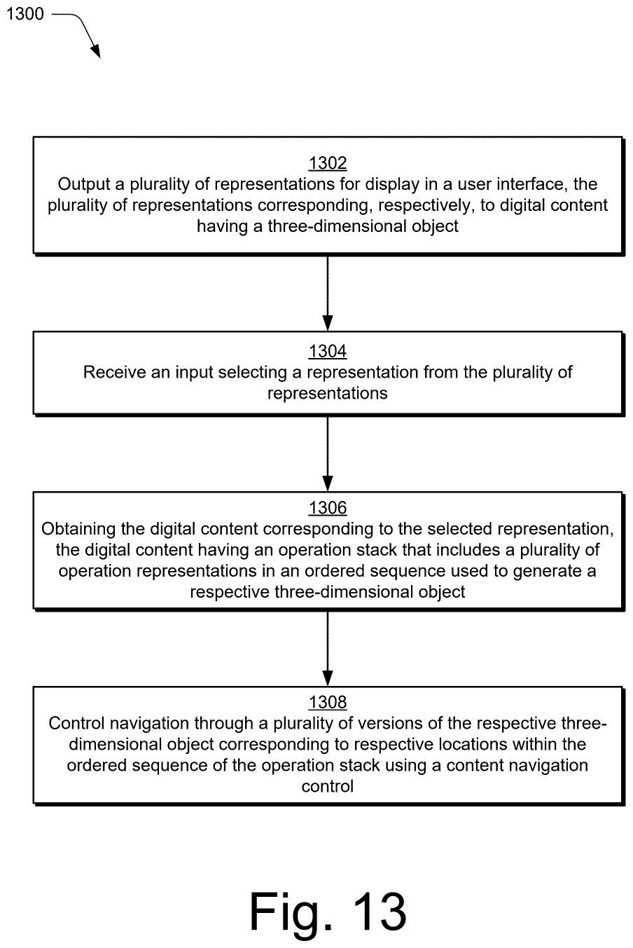

FIG. 12 depicts a system 1200 in an example implementation showing operation of a digital search service of the digital services 116 of FIG. 1 in greater detail as locating an item of digital content having an operation stack. FIG. 13 is a flow diagram depicting an algorithm as a step-by-step procedure 1300 in an example implementation of operations performable for accomplishing a result of a digital content search to locate an item of digital content. The following discussion of the system 1200 of FIG. 12 is made in parallel with the procedure 1300 of FIG. 13.

The digital services 116 in this example include a digital search service 1202 that is configured to search a storage device 1204 to locate digital content 110 from a plurality of digital content. The digital search service 1202, for instance, is configurable as part of stock content service, a social media service, and so on. For example, the digital search service 1202 receives a search query 1206 via a user interface 1208 as text specifying “3D Homes in a Neighborhood” and generates a search result 1210. Other examples are also contemplated, such as an image search in which a digital image acts as the search query 1206.

The search result 1210 is then output by the digital search service 1202 for display in the user interface 1208, e.g., at the client device 104. The search result 1210 includes a plurality of representations 1212, 1214, 1216, 1218, 1220, 1222 corresponding, respectively, to digital content having a three-dimensional object (block 1302). The plurality of representations 1212-1222 in the illustrated example are configured as thumbnails including depictions of respective three-dimensional environments.

An input 1224 is then received as selecting a representation 1212 from the plurality of representations 1212-1222 (block 1304), e.g., via a cursor control device, gesture, spoken utterance, or other input received via the user interface 1208 at the client device 104 and communicated to the service provider system 102. Digital content 110 corresponding to the selected representation is obtained that includes the operation stack 1008 having a plurality of operation representations in an ordered sequence used to generate a respective digital object (block 1306) as well as respective portions of the attribution data 1014. Navigation is then controlled through a plurality of versions of the respective three-dimensional object 124 corresponding to respective locations within the ordered sequence of the operation stack 1008 using a content navigation control 128 (block 1308), further discussion of which is included in the following example.

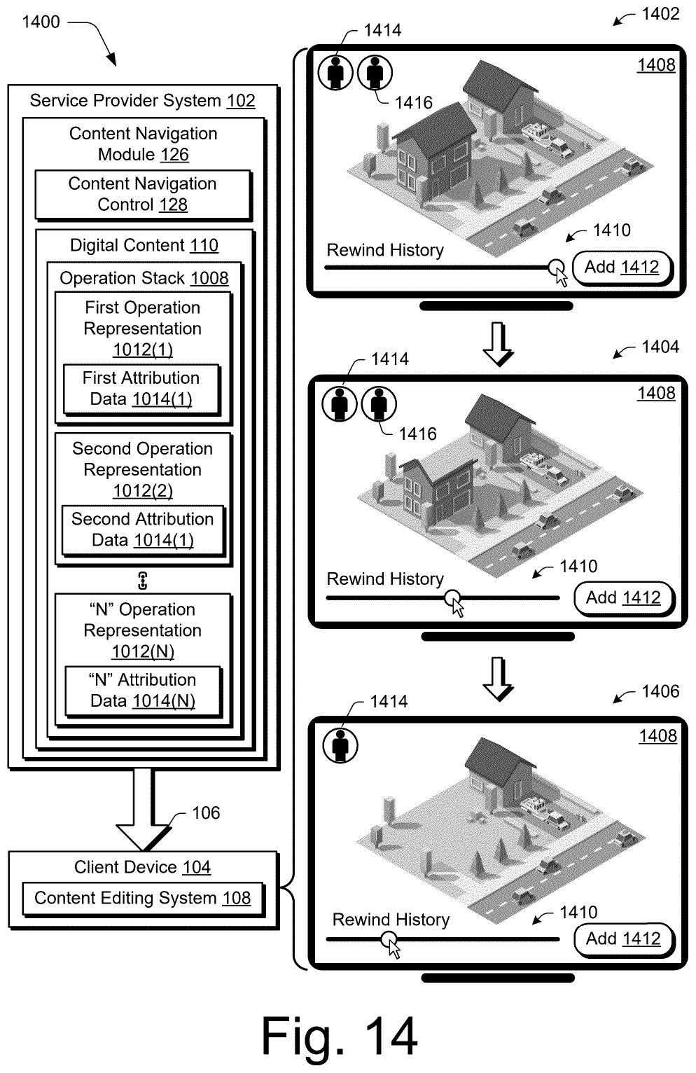

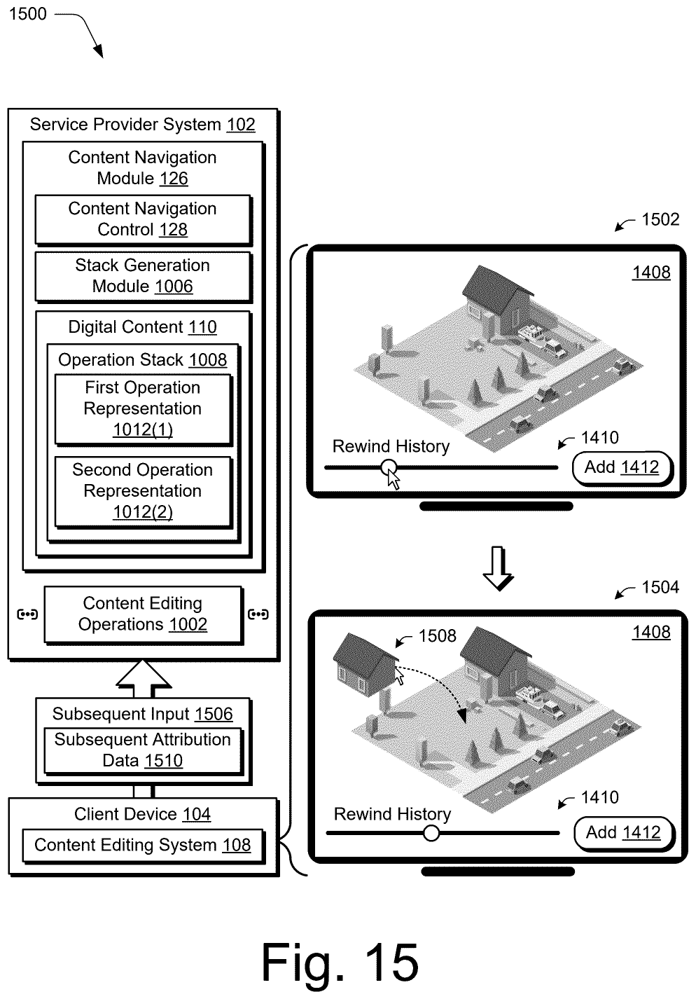

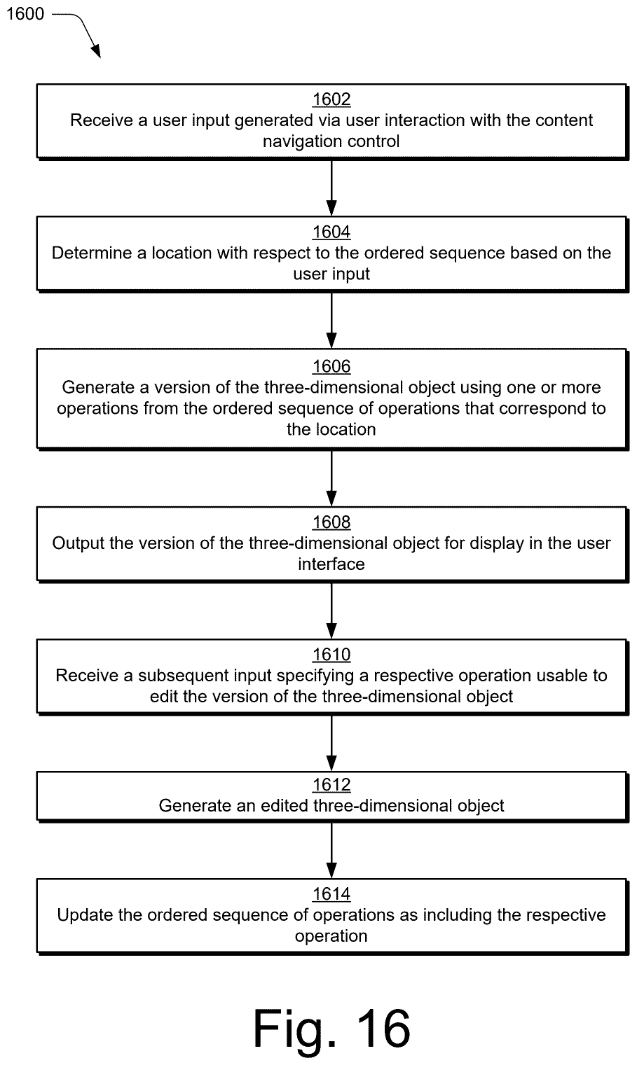

FIG. 14 depicts a system 1400 in an example implementation showing operation of a content navigation module of FIG. 1 in greater detail as implementing a content navigation control to navigate through an operation stack of an item of digital content. FIG. 15 depicts a system 1500 in an example implementation showing interaction with a content navigation control to navigate through an operation stack to initiate creation of a new item of digital content. FIG. 16 is a flow diagram depicting an algorithm as a step-by-step procedure 1600 in an example implementation of operations performable for accomplishing a result of navigation through operation representations to control output of corresponding versions of digital content using a content navigation control. The following discussion of the systems 1400 and 1500 of FIGS. 13 and 15 is made in parallel with the procedure 1600 of FIG. 16.

In the illustration of FIG. 14, the content navigation module 126 and content navigation control 128 are executed at the service provider system 102 to navigate through the operation representations of the operation stack 1008. A result of which is rendered and communicated via the network 106 for output at a display device of the client device 104. Other examples are also contemplated in which the digital content 110 having the operation stack 1008 is communicated over the network 106 to the client device 104, is generated locally at the client device 104, and so on. This illustration is depicted using a first stage 1402, a second stage 1404, and a third stage 1406 that show a user interface 1408 displayed on a display device of the client device 104.

Regardless of how implemented, a user input is received. The user input is generated via user interaction with the content navigation control 128. The content navigation control 128 is configured to navigate through an ordered sequence of operations used to generate the three-dimensional object (block 1602). In the illustrated example, the content navigation module 126 is depicted as a slider 1410, although other examples are also contemplated such as a dial or other representation usable to indicate respective locations in an ordered sequence, as input as a numerical value, and so on.

As shown at the first stage 1402, for instance, a user input is received as selecting the slider 1410 using a cursor control device and is navigated backward through a “rewind history” of generation of the digital content 110 as shown at the second stage 1404. An option 1412 is also included in the user interface to “add” the three-dimensional object 124 and/or three-dimensional environment 122 to another item of digital content.

A determination is then made as to a location with respect to the ordered sequence based on the user input (block 1604), e.g., by the content navigation module 126 of the service provider system 102 and/or the client device 104. The content navigation module 126, for instance, determines which operation representation in the operation stack 1008 corresponds to the user input based on a relative location of the input with respect to a length of the ordered sequence as represented by the content navigation control 128. In response, the content navigation module 126 generates a version of the three-dimensional object using one or more operations from the ordered sequence of operations that correspond to the location (block 1606). The version of the three-dimensional object 124 is then output for display in the user interface (block 1608) as shown in the user interface 1408 at the second stage 1404.

This process may continue as shown at the third stage 1406 in support of real time output such that as inputs are received specifying different locations with respect to the content navigation control 128, corresponding versions of the digital content 110 are rendered for display in the user interface 1408. At the first stage 1402, for instance, a user input is received to navigate backwards through the operation stack 1008. In response, a roof of a house is removed as depicted at the second stage 1404, with an entirety of the house removed at the third stage 1402. In this way, navigation is supported through the operation representations to gain insight into how corresponding versions of the three-dimensional object 124 and consequently the three-dimensional environment 122 are created.

The operation stack 1008, as illustrated, includes a first operation representation 1012(1), a second operation representation 1014(2) through an “N” operation representation 1012(N). Each of the operation representations include attribution data that identifies an entity that initiated the represented operations. Illustrated examples of which include first attribution data 1014(1), second attribution data 1014(2) through “N” attribution data 1014(N). The attribution data 1014 is usable to generate representations of a first entity 1414 and a second entity 1416 that initiated respective operations.

At the first and second stages 1402, 1404, for instance, the first and second entities initiated corresponding operations used to create the depicted digital content and as such are represented in the user interface. Removal of the house at the third stage 1406, however, causes removal of a representation of the second entity 1416 from the user interface 1408 that is associated with creation of that object. The representation of the first entity 1414 remains.

Additional features are also contemplated, examples of which include depictions of execution of the plurality of content editing operations 1002 in a user interface. The user interface 214, in another example, is configurable to depict, non-modally, the operation representations from the operation stack 1008 corresponding to a current version of the digital content 110 as rendered in the user interface 214, e.g., which operation representation are applied and which are not.

Navigation is supported both forward and backward through the operation stack 1008 using the content navigation control 128. Further, as previously described the content navigation control 128 supports output of “real editable” versions of the digital content 110 and consequently supports subsequent user edits that may serve as a starting point to form “new” versions of the digital content 110 and thus increase user efficiency.

The example system 1500 of FIG. 15, for instance, is also depicted using a first stage 1502 and a second stage 1504. Continuing the previous example, user interaction with the user interface 1408 specifies a location within the operation stack 1008, which in this example has a three-dimensional object of a house removed from the digital content 110 as shown in FIG. 14.

A creative in this example then desires to replace the removed house with a different house 1508 as shown at the second stage 1504. To do so, a subsequent input 1506 is generated by the content editing system 108 and is received by the service provider system 102. The subsequent input 1506 specifies a respective content editing operation 1002 (i.e., subsequent operation) that is usable to edit the version of the three-dimensional object (block 1610) as depicted in the user interface 1408, e.g., to add the different house 1508. The subsequent input also includes subsequent attribution data 1510 referencing the entity that initiate the operation, e.g., the creative. Accordingly, an edited three-dimensional object is generated (block 1612) for inclusion in the three-dimensional environment 122.

The ordered sequence of operations is also updated by the stack generation module 1006 to include the respective operation (block 1614) and attribution data. In an implementation, for instance, the version of the digital content at the first stage 1502 is generated using one or more operations that correspond to the location specified by the content navigation control 128, e.g., that correspond to the first operation representation 1012(1) and the second operation representation 1012(2). The stack generation module 1006 is then utilized to configure the ordered sequence of the operation stack 1008 to include a subsequent operation representation of the subsequent operation, e.g., used to add the other house. The operation stack 1008 is also updated to include the subsequent attribution data 1510. In this way, the stack generation module 1006 is configured to respond dynamically and in real time to changes made to the digital content 110.

Operation representations that do not correspond to that location are discarded in one example, e.g., such that the updated ordered sequence does not include an operation representation of those operations occurring after the location in the ordered sequence used as the starting point in the above example. Other examples are also contemplated in which each of the operation representations are maintained, e.g., as branches within the ordered sequence of the operation stack 1008. In this way, the content navigation module 126 and content navigation control 128 support increased insight into creation of three-dimensional environment 122 and three-dimensional object 124 in digital content 110 of interest, which is not possible in conventional techniques.

### Example System and Device

FIG. 17 illustrates an example system generally at 1700 that includes an example computing device 1702 that is representative of one or more computing systems and/or devices that implement the various techniques described herein. This is illustrated through inclusion of the content editing system 108 and three-dimensional digital service 120. The computing device 1702 is configurable, for example, as a server of a service provider, a device associated with a client (e.g., a client device), an on-chip system, and/or any other suitable computing device or computing system.

The example computing device 1702 as illustrated includes a processing device 1704, one or more computer-readable media 1706, and one or more I/O interface 1708 that are communicatively coupled, one to another. Although not shown, the computing device 1702 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 1704 is representative of functionality to perform one or more operations using hardware. Accordingly, the processing device 1704 is illustrated as including hardware element 1710 that is configurable as processors, functional blocks, and so forth. This includes implementation in hardware as an application specific integrated circuit or other logic device formed using one or more semiconductors. The hardware elements 1710 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1706 is illustrated as including memory/storage 1712 that stores instructions that are executable to cause the processing device 1704 to perform operations. The memory/storage 1712 represents memory/storage capacity associated with one or more computer-readable media. The memory/storage 1712 includes volatile media (such as random access memory (RAM)) and/or nonvolatile media (such as read only memory (ROM), Flash memory, optical disks, magnetic disks, and so forth). The memory/storage 1712 includes fixed media (e.g., RAM, ROM, a fixed hard drive, and so on) as well as removable media (e.g., Flash memory, a removable hard drive, an optical disc, and so forth). The computer-readable media 1706 is configurable in a variety of other ways as further described below.

Input/output interface(s) 1708 are representative of functionality to allow a user to enter commands and information to computing device 1702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1702 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1702. By way of example, and not limitation, computer-readable media includes “computer-readable storage media” and “computer-readable signal media. ” “Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1702, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1710 and computer-readable media 1706 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1710. The computing device 1702 is configured to implement particular instructions and/or functions corresponding to the software and/or hardware modules. Accordingly, implementation of a module that is executable by the computing device 1702 as software is achieved at least partially in hardware, e.g., through use of computer-readable storage media and/or hardware elements 1710 of the processing device 1704. The instructions and/or functions are executable/operable by one or more articles of manufacture (for example, one or more computing devices 1702 and/or processing devices 1704) to implement techniques, modules, and examples described herein.

The techniques described herein are supported by various configurations of the computing device 1702 and are not limited to the specific examples of the techniques described herein. This functionality is also implementable all or in part through use of a distributed system, such as over a “cloud” 1714 via a platform 1716 as described below.

The cloud 1714 includes and/or is representative of a platform 1716 for resources 1718. The platform 1716 abstracts underlying functionality of hardware (e.g., servers) and software resources of the cloud 1714. The resources 1718 include applications and/or data that can be utilized while computer processing is executed on servers that are remote from the computing device 1702. Resources 1718 can also include services provided over the Internet and/or through a subscriber network, such as a cellular or Wi-Fi network.

The platform 1716 abstracts resources and functions to connect the computing device 1702 with other computing devices. The platform 1716 also serves to abstract scaling of resources to provide a corresponding level of scale to encountered demand for the resources 1718 that are implemented via the platform 1716. Accordingly, in an interconnected device embodiment, implementation of functionality described herein is distributable throughout the system 1700. For example, the functionality is implementable in part on the computing device 1702 as well as via the platform 1716 that abstracts the functionality of the cloud 1714.

In implementations, the platform 1716 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving, by a processing device, a selection of a mode from a plurality of modes specifying object interactions in a user interface;
receiving, by the processing device, an input via the user interface specifying movement of a first object in relation to a second object;
detecting, by the processing device, an intersection between a first three-dimensional volume defined for the first object with a second three-dimensional volume defined for the second object;
performing, by the processing device, an image editing operation based on the mode and the detected intersection; and
presenting, by the processing device, a result of performing the image editing operation based on the first and second objects in the user interface.

2. The method as described in claim 1, wherein the image editing operation is an add operation in which the first three-dimensional volume defined for the first object appears disposed within the second three-dimensional volume defined for the second object in the user interface.

3. The method as described in claim 1, wherein the image editing operation is a carve operation in which a portion of the first three-dimensional volume is removed in the user interface that intersects the second three-dimensional volume defined for the second object.

4. The method as described in claim 1, wherein the image editing operation is an intersect operation in which an overlapping portion of both the first object and the second object is removed in the user interface that intersect each other based on respective first and second three-dimensional volumes.

5. The method as described in claim 1, wherein the image editing operation is a color operation in which a portion of a surface of the first three-dimensional volume that intersects the second three-dimensional volume defined for the second object is defined to have a color based on the second object.

6. The method as described in claim 1, wherein the image editing operation is a repel operation in which a portion of the first three-dimensional volume that intersects the second three-dimensional volume defined for the second object is repelled from the second object as following the movement defined by the input.

7. The method as described in claim 6, wherein the repel operation employs a blending factor that is user definable via the user interface to define a distance between the portion of the first three-dimensional volume and the second three-dimensional volume.

8. The method as described in claim 1, wherein the image editing operation is an avoid operation in which a portion of the second three-dimensional volume that intersects the first three-dimensional volume defined for the first object avoids the second three-dimensional volume as following the movement defined by the input.

9. The method as described in claim 8, wherein the avoid operation employs a blending factor that is user definable via the user interface to define a distance between the portion of the second three-dimensional volume and the first three-dimensional volume.

10. A computing device comprising:
a processing device; and
a computer-readable storage medium storing instructions that, responsive to execution by the processing device, causes the processing device to perform operations including:
receiving an input via a user interface specifying movement of a first object in relation to a second object;
detecting an intersection as following the movement between a first three-dimensional volume defined for the first object with a second three-dimensional volume defined for the second object;
performing an image editing operation for display as being applied to the first or second object based on the detected intersection; and
presenting a result of performing the image editing operation on the first and second objects in the user interface as following the movement in real time as the input is received.

11. The computing device as described in claim 10, wherein the image editing operation is an add operation in which the first three-dimensional volume defined for the first object appears disposed within the second three-dimensional volume defined for the second object in the user interface.

12. The computing device as described in claim 10, wherein the image editing operation is a carve operation in which a portion of the first three-dimensional volume is removed in the user interface that intersects the second three-dimensional volume defined for the second object.

13. The computing device as described in claim 10, wherein the image editing operation is an intersect operation in which intersections portions of the first and second objects remain and nonintersecting portions of the first and second objects are removed from display in the user interface.

14. The computing device as described in claim 10, wherein the image editing operation is a color operation in which a portion of a surface of the first three-dimensional volume that intersects the second three-dimensional volume defined for the second object is defined to have a color based on the second object.

15. The computing device as described in claim 10, wherein the image editing operation is a repel operation in which a portion of the first three-dimensional volume that intersects the second three-dimensional volume defined for the second object is repelled from the second object as following the movement defined by the input.

16. The computing device as described in claim 10, wherein the image editing operation is an avoid operation in which a portion of the second three-dimensional volume that intersects the first three-dimensional volume defined for the first object avoids the second three-dimensional volume as following the movement defined by the input.

17. A method comprising:
receiving, by a processing device, a user input generated via user interaction with a content navigation control, the content navigation control configured to navigate through an ordered sequence of operations used to generate a three-dimensional object;
determining, by the processing device, a location with respect to the ordered sequence based on the user input;
generating, by the processing device, a version of the three-dimensional object using one or more operations from the ordered sequence of operations that correspond to the location;
generating, by the processing device, a representation of an entity that initiated a respective said operation; and
presenting, by the processing device, the version of the three-dimensional object and the representation for display in a user interface.

18. The method as described in claim 17, wherein the representation attributes the respective said operation to the entity.

19. The method as described in claim 17, wherein the representation identifies the entity.

20. The method as described in claim 17, wherein the representation is generated based on attribution data associated with the respective said operation.
